(19) United States
(12) Patent Application Publication
(10) Pub. No.: US 2026/0307972 A1
(43) Pub. Date: Oct. 8, 2026

(54) DEVICE AND METHOD FOR FILLING A CONTAINER WITH LIQUID

(71) Applicants: Devra Jeanne Olson, Monroe, WA (US); Chad Robert Olson, Monroe, WA (US)

(72) Inventors: Devra Jeanne Olson, Monroe, WA (US); Chad Robert Olson, Monroe, WA (US)

(21) Appl. No.: 19/640,794

(22) Filed: Apr. 7, 2026

Related U.S. Application Data
(60) Provisional application No. 63/784,572, filed on Apr. 7, 2025.

(51) Int. Cl. B67C 3/26; B05B 1/20; B33Y 80/00

(52) U.S. Cl. CPC B67C 3/26; B05B 1/20; B33Y 80/00

(57) ABSTRACT

A device for filling a container with liquid without being attached to the container or another stationary object and without being held by a person during filling includes a hollow body having an interior bore configured to be placed into liquid communication with a liquid source such that liquid flows from the liquid source into the interior bore; and a plurality of openings defined within the hollow body and configured to enable the flow of liquid out of the interior bore, wherein the hollow body is configured to substantially maintain its position within a container as the container is filling with liquid flowing from the liquid source and out of the plurality of openings substantially regardless of liquid pressure.

### CROSS-REFERENCE TO RELATED APPLICATION

This application claims the benefit of U.S. Provisional Application No. 63/784572, filed Apr. 7, 2025, the entire contents of which are incorporated herein by reference.

### BACKGROUND

Filling a bucket or other container with a garden hose or a similar type of liquid source frequently involves issues with water pressure management, hose handling, and splash control, among other issues. For instance, if left unattended, a hose typically flies out of a bucket because of high water pressure and nozzle reaction, as shown in the prior art view of FIG. 1. The force of water rushing out creates an equal and opposite force that makes the hose move, often exacerbated by the hose bending. The water's high speed, combined with the hose's flexibility, causes it to whip or jump. Without a secure, heavy, or anchored nozzle, the hose can jump or whip around under high pressure, falling out of the container.

To manage hose movement, the end of the hose may be secured relative to the container. For instance, a person may hold the hose near its end/nozzle to ensure it does not move or whip around. However, the person must wait for the container to fill, which can take many minutes. Thus, the person cannot attend to other activities or chores (such as cleaning stalls, fixing fences, feeding animals, etc., on a farm) while waiting for the container to fill.

Instead, a small weight (like a piece of metal or a scrubbing brush) may be placed on top of the hose inside the container to keep the hose in place. However, suitable devices are not easily found, nor are they typically the proper weight and/or shape for engaging and securing a hose end.

As yet another alternative, the hose may be secured to a clamp, hook, or the like that is located relative to the container. However, some containers (e.g., troughs) cannot be moved or easily adapted with a device for securing the hose.

As yet another alternative, the water pressure may be lowered such that the force of water coming out of the hose end is insufficient to make the hose move. However, when the water pressure is lowered, the time it takes to fill the container can be proportionately increased.

Thus, an improved system/method for filling a container with liquid, such as filling a bucket with water from a garden hose, is desired.

### SUMMARY

In some aspects, the techniques described herein relate to a device for filling a container with liquid without being attached to the container or another stationary object and without being held by a person during filling, the device including: a hollow body having an interior bore configured to be placed into liquid communication with a liquid source such that liquid flows from the liquid source into the interior bore; and a plurality of openings defined within the hollow body and configured to enable the flow of liquid out of the interior bore, wherein the hollow body is configured to substantially maintain its position within a container as the container is filling with liquid flowing from the liquid source and out of the plurality of openings substantially regardless of liquid pressure.

In some aspects, the techniques described herein relate to a hose attachment device, including: a hollow body having an interior bore configured to be placed into liquid communication with a garden hose such that water flows from the garden hose into the interior bore; and a plurality of openings defined within the hollow body and configured to enable the flow of water out of the interior bore, wherein the hollow body substantially maintains its position within a container as the container is filling with water flowing from the garden hose and out of the plurality of openings, substantially regardless of water pressure, without the hose attachment device being attached to the container or another stationary object and without the hose attachment device being held by a person during filling.

In some aspects, the techniques described herein relate to a method of filling a container with water from a garden hose using a hose attachment device having a hollow body with an interior bore and a plurality of openings configured to enable a flow of water out of the interior bore, the method including: placing the hose attachment device into liquid communication with a garden hose such that water flows from the garden hose into the interior bore; placing the hose attachment device into a container to be filled with water from the garden hose; flowing water from the garden hose through the interior bore and out of the plurality of openings defined within the hollow body; and substantially maintaining a position of the hose attachment device within the container as the container is filling with water flowing from the garden hose and out of the plurality of openings, substantially regardless of water pressure, without the hose attachment device being attached to the container or another stationary object and without the hose attachment device being held by a person during filling.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an exemplary environmental view of a container being filled with water from a garden hose using prior art methods.

FIG. 2 is an exemplary environmental view of a container being filled with water from a garden hose using a device for filing a container with liquid in accordance with examples herein.

FIG. 3 is an isometric view of the device for filing a container with liquid as shown in FIG. 2.

FIG. 4 is a first side view of the device for filing a container with liquid as shown in FIG. 3.

FIG. 5 is a second side view of the device for filing a container with liquid as shown in FIG. 3.

FIG. 6 is a top, plan view of the device for filing a container with liquid as shown in FIG. 3.

### DETAILED DESCRIPTION

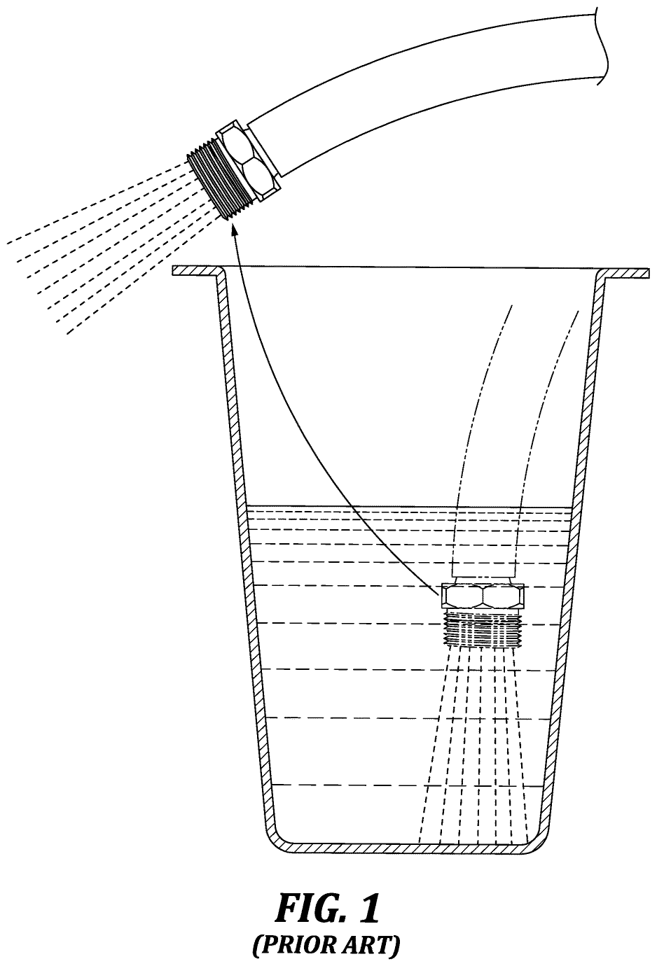

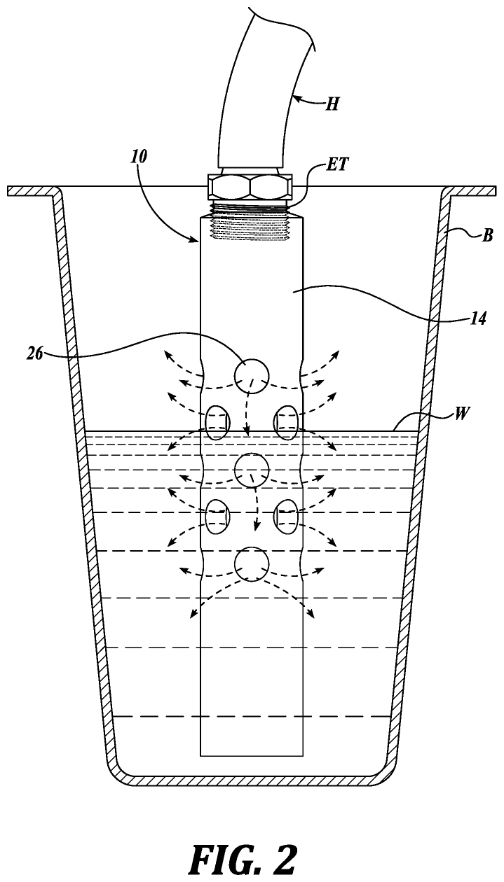

The present disclosure relates to an improved device/method for filling a container with liquid from a liquid source, such as filling a bucket with water from a garden hose. With reference to FIG. 2, the improved device for filling a container with liquid from a liquid source is embodied as a hose attachment device 10 that is generally configured to secure an end of a hose H within an interior of a container, such as a bucket B, without being attached to the container or another stationary object (e.g., a hook on a wall) and without being held by a person during filling. Rather, the hose attachment device 10 secures only the end of the hose H within the interior of the container while the container is being filled with liquid, regardless of water pressure. In that regard, the hose H and the coupled hose attachment device 10 can be left unattended and unattached to the bucket B or another structure while it is being filled with water, without allowing the hose to fly out of the bucket (as shown in the prior art view of FIG. 1). In other words, the hose attachment device 10 is attached only to the hose, and filling a container with a hose is thus not dependent on attachment of the hose attachment device 10 or hose to a container (e.g. bucket, trough, vessel, etc.) or other structure. Rather, the hose attachment device 10 is a standalone product, it is fully mobile with a hose, and it is easily moveable to another container.

It should be appreciated that although the hose attachment device 10 is described as being used with a garden hose, the device may be adapted for use with any suitable liquid source conduit. Moreover, although the hose attachment device 10 is described as being used to fill a bucket with water, it should be appreciated that the device may be used with any suitable liquid and any suitable liquid-holding container. Thus, the descriptions and illustrations provided herein should not be seen as limiting.

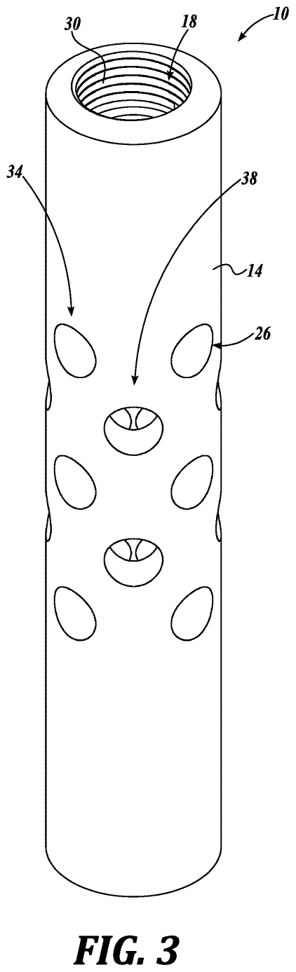

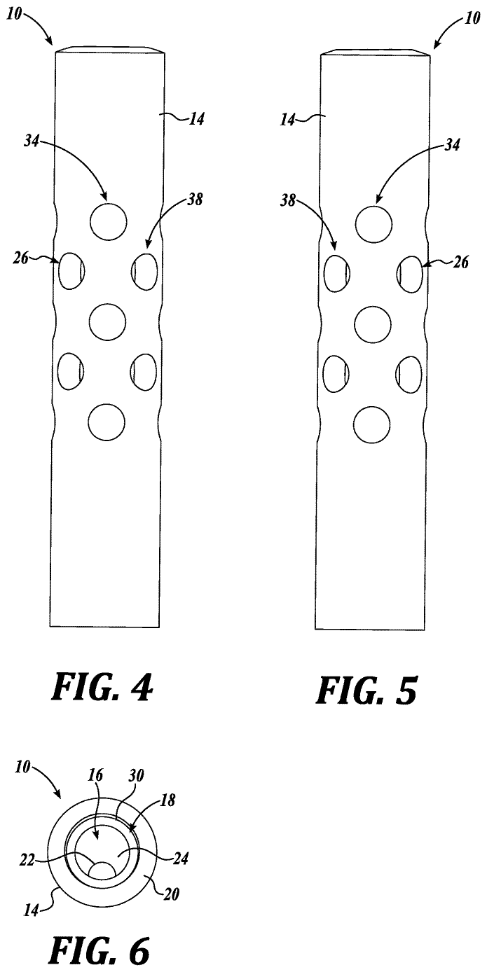

Detailed exemplary aspects of the hose attachment device 10 will now be described with additional reference to FIGS. 3-6. The hose attachment device 10 includes a hollow body 14 having an interior configured to receive liquid from the hose H. In the depicted example, the hollow body 14 is elongated and substantially cylindrical in overall shape and has an elongated substantially cylindrical interior bore 16 defined by a cylindrical wall 20. The elongated substantially cylindrical interior bore 16 extends from a top opening 18 in the hollow body 14 (generally defined by the cylindrical wall 20) towards a substantially flat bottom 24 of the body. The substantially flat bottom 24 enables the hose attachment device 10 to be set vertically on a surface, such as for storage. Of course, other bottom shapes may instead be used. A plurality of openings 26 is defined within the cylindrical wall 20 of the hollow body 14 for facilitating exit of liquid from the body. Exemplary aspects of the openings, including the number, type, size, arrangement, etc., will be described further below. Although the hollow body 14 is shown as an elongated cylindrical shape, any suitable shape may be used (e.g., rectangular, spherical, etc.).

The hollow body 14 may also be any suitable size and material such that it can secure a hose end within a container while the container is being filled with liquid, regardless of water pressure, while also being suitably lightweight for ease of use. For instance, the hollow body 14 may be made from a durable, UV resistant, food grade material, such as polyethylene terephthalate glycol (PETG or PET-G).

In some examples, the hollow body 14 is a hollow elongated cylinder made of thermoplastic polymer material (optionally food-grade), approximately eight inches (8″) long and one and one-half inches (1 ½″) in diameter, with about a one quarter inch (¼″) thick cylindrical wall 20. However, it should be appreciated that the hollow body 14 may instead be made of another material (e.g., metal), and it may be any suitable size. For instance, if the hollow body 14 was made of a heavier material, such as a certain type of metal, the body may be shorter in length, smaller in diameter, and/or less thick than that described above. Less volume of a heavier material may be needed to secure a hose end within a container while the container is being filled with liquid, regardless of water pressure.

In some examples, the hollow body 14 is an integrated design, e.g., made from a single piece of material, such as by 3-D printing, injection molding, or the like. In that regard, the hose attachment device 10 is a simple and durable design having no separable parts, moveable parts, etc., that are otherwise susceptible to breaking/failing.

The hose attachment device 10 is generally configured to be selectively (e.g., temporarily) secured to an end of a garden hose H. In the depicted example, the hose attachment device 10 is threadably secured to a male, external threaded section ET at the end of the garden hose H. In that regard, the hose attachment device 10 includes a female threaded section 30 defined at an upper end of the hollow body 14 within the elongated substantially cylindrical interior bore 16, near or adjacent to the top opening 18. Any suitable threaded interface may be used.

Typically, an end of a garden hose includes a male, external threaded section ET that is mateable to a female threaded device. For instance, the standard garden hose male thread size in the United States is three-fourths inch (¾″) GHT (Garden Hose Thread), which measures 11.5 threads per inch (TPI). This standardized, straight male thread is used on nearly all hoses. Thus, in some examples, the female threaded section 30 is configured to threadably mate with a ¾″ GHT. In some examples, an adapter may be threadably secured within the female threaded section 30 such that the hose attachment device 10 may be secured to hoses or other liquid conduits of different sizes/thread types.

In some examples, a seal, washer, gasket, etc., may be inserted between the hose attachment device 10 and the garden hose H (e.g., between the female threaded section 30 and the male, external threaded section ET of the hose) to facilitate sealing. However, as will be appreciated, sealing of the hose attachment device 10 onto the hose end may not be necessary if the hose attachment device 10 is used only to facilitate, rather than stop, liquid flow.

Exemplary aspects of the plurality of openings 26 will now be described in detail. As noted above, the plurality of openings 26 is defined within the cylindrical wall 20 of the hollow body 14 for facilitating exit of liquid from the body. In that regard, the plurality of openings 26 is of a suitable number, type, size, arrangement, etc., to allow liquid to suitably exit the hollow body 14, regardless of water pressure, without causing the hose attachment device 10 to fly out of the bucket (as shown in the prior art view of FIG. 1).

In the depicted example, the plurality of openings 26 may be of a suitable size and may be spaced from other openings to enable suitable liquid flow. For instance, each of the plurality of openings 26 may be about one half inch (½″) in diameter. Moreover, each of the plurality of openings 26 may be substantially cylindrical in overall shape (e.g., having a straight wall extending substantially transversely between an outer and inner surface of the hollow body 14). Further, with the cylindrical wall 20 being about one quarter inch (¼″) thick, the height or length of each of the plurality of openings 26 extending through the wall would be about ¼″.

As noted above, each of the plurality of openings 26 is also suitably spaced from other openings to enable suitable liquid flow. In the depicted example, the hose attachment device 10 includes plurality of openings 26 that are arranged in a substantially evenly spaced pattern around the circumference of the hollow body 14. In the depicted example, each of the plurality of openings 26 is spaced from any of the other plurality of openings 26 by about one half inch (½″).

The pattern of the plurality of openings 26 may be defined by a plurality of first opening columns 34 interspaced by a plurality of second opening columns 38. The plurality of first opening columns 34 may extend substantially axially along at least a portion of the hollow body 14, and may include a first number of openings, such as three openings. The plurality of second opening columns 38 may also extend substantially axially along at least a portion of the hollow body 14, and may include a second number of openings less than the first number of openings, such as two openings. The first and second opening columns 34 and 38 may extend next to each other in a repeating pattern around the circumference of the hollow body 14. In that regard, openings are spaced axially around the circumference of the hollow body 14.

Moreover, the plurality of first opening columns 34 may be staggered axially from the plurality of second opening columns 38. With the plurality of second opening columns 38 having a second number of openings less than the first number of openings of the plurality of first opening columns 34, the openings in adjacent columns are also spaced diagonally relative to one another. In that regard, a substantially even and distributed flow of liquid may flow out of the plurality of openings 26 in a substantially 360-degree flow pattern.

The plurality of openings 26 may be formed/defined in a middle axial portion of the hollow body 14. In that regard, the plurality of openings 26 are substantially concentrated in a middle axial portion of the hose attachment device 10. As a result, a bottom axial portion of the hollow body 14 can act as a weight or anchor for retaining the hose H within the bucket. Moreover, water does not flow out of the top axial portion of the hose attachment device 10, which could spray out of the bucket B.

The hose attachment device 10 may be further configured to facilitate drainage of liquid after use. In the depicted example, a drain hole 22 is defined in the substantially flat bottom 24 of the hollow body 14. In that regard, liquid can drain out of the drain hole 22 (in lieu of or addition to being drained out of the plurality of openings 26), such as when the hose attachment device 10 and hose are lifted out of the container after filling.

Using the hose attachment device 10, a bucket or other container can be filled with water from a hose or the like without requiring the end of the hose to be secured to the container, held by a person, etc. Moreover, the hose attachment device 10 is uniquely designed to secure the hose within the container, even with high water pressure.

An exemplary method of filling a container with water from a garden hose using a hose attachment device having a hollow body with an interior bore and a plurality of openings configured to enable the flow of water out of the interior bore will now be described. The exemplary method will be described with reference to the hose attachment device 10, however, any suitable hose attachment device may be used that can perform substantially the same function. Moreover, the method steps need not necessarily be carried out in the order described.

The method may include placing the hose attachment device 10 into liquid communication with a garden hose such that water flows from the garden hose into the elongated substantially cylindrical interior bore 16. For instance, the hose attachment device 10 may be threadably secured onto the garden hose like a standard garden hose attachment. With the hose attachment device 10 secured to the garden hose, the hose attachment device 10 may be placed into a container (e.g., a bucket) to be filled with water from the garden hose. The garden hose may be turned on such that water flows from the garden hose through the elongated substantially cylindrical interior bore 16 and out of the plurality of openings 26 defined within the hollow body 14. While the container is being filled, and without holding onto the hose attachment device 10 or otherwise securing the hose attachment device 10 relative to the container, the position of the hose attachment device 10 is substantially maintained within the container, substantially regardless of water pressure. The method may include substantially distributing the flow of water out of the plurality of openings 26 in a substantially 360-degree flow pattern.

While the concepts of the present disclosure are susceptible to various modifications and alternative forms, specific examples thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one example,” “an example,” etc., indicate that the example described may include a particular feature, structure, or characteristic, but every example may or may not necessarily include that particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

Language such as “up”, “down”, “left”, “right”, “first”, “second”, etc., in the present disclosure is meant to provide orientation for the reader with reference to the drawings and is not intended to be the required orientation of the components or graphical images or to impart orientation limitations into the claims.

In the drawings, some structural or method features may be shown in specific arrangements and/or orderings. However, it should be appreciated that such specific arrangements and/or orderings may not be required. Rather, in some examples, such features may be arranged in a different manner and/or order than shown in the illustrative FIG. Additionally, the inclusion of a structural or method feature in a particular FIG. is not meant to imply that such feature is required in all examples and, in some examples, it may not be included or may be combined with other features.

As used herein, the terms “about”, “approximately,” etc., in reference to a number, is used herein to include numbers that fall within a range of 10%, 5%, or 1% in either direction (greater than or less than) the number unless otherwise stated or otherwise evident from the context (except where such number would exceed 100% of a possible value).

Headings of sections provided in this patent application and the title of this patent application are for convenience only and are not to be taken as limiting the disclosure in any way.

While illustrative embodiments have been illustrated and described, it will be appreciated that various changes can be made therein without departing from the spirit and scope of the invention.

The embodiments of the invention in which an exclusive property or privilege is claimed are defined as follows:

1. A device for filling a container with liquid without being attached to the container or another stationary object and without being held by a person during filling, the device comprising:
a hollow body having an interior bore configured to be placed into liquid communication with a liquid source such that liquid flows from the liquid source into the interior bore; and
a plurality of openings defined within the hollow body and configured to enable the flow of liquid out of the interior bore,
wherein the hollow body is configured to substantially maintain its position within a container as the container is filling with liquid flowing from the liquid source and out of the plurality of openings substantially regardless of liquid pressure.

2. The device of claim 1, wherein the body has an opening in communication with the interior bore, the opening defining a female threaded section threadable onto a male threaded section of a garden hose when the garden hose defines the liquid source.

3. The device of claim 1, wherein the interior bore is a substantially elongated cylindrical shape, and wherein the hollow body is defined by a cylindrical wall that circumferentially surrounds the interior bore.

4. The device of claim 3, wherein the hollow body is a 3-D printed cylinder made of thermoplastic polymer material, approximately eight inches long and one and one-half inches in diameter, with about a one quarter inch thick cylindrical wall.

5. The device of claim 3, wherein each of the plurality of openings extend through the cylindrical wall.

6. The device of claim 3, wherein the plurality of openings are arranged in a substantially evenly spaced pattern around a circumference of the hollow body.

7. The device of claim 6, wherein each of the plurality of openings is spaced from any of the other plurality of openings by about one half inch.

8. The device of claim 6, wherein the pattern of the plurality of openings is defined by a plurality of first opening columns interspaced by a plurality of second opening columns, the plurality of first opening columns extending substantially axially along at least a portion of the hollow body and including a first number of openings, the plurality of second opening columns extending substantially axially along at least a portion of the hollow body and including a second number of openings less than the first number of openings, wherein the first and second opening columns extend axially next to each other in a repeating pattern around the circumference of the hollow body.

9. The device of claim 8, wherein the plurality of first opening columns is staggered axially from the plurality of second opening columns.

10. The device of claim 6, wherein the pattern of the plurality of openings is configured to produce substantially even and distributed flow of liquid out of the plurality of openings in a substantially 360-degree flow pattern.

11. The device of claim 4, wherein the hollow body is made from polyethylene terephthalate glycol.

12. The device of claim 1, wherein the plurality of openings are arranged in a substantially evenly spaced pattern around a circumference of a middle axial portion of the hollow body.

13. The device of claim 12, wherein the pattern of the plurality of openings is defined by a plurality of first opening columns interspaced by a plurality of second opening columns, the plurality of first opening columns extending substantially axially along at least a portion of the hollow body and including a first number of openings, the plurality of second opening columns extending substantially axially along at least a portion of the hollow body and including a second number of openings less than the first number of openings, wherein the first and second opening columns extend axially next to each other in a repeating pattern around the circumference of the hollow body.

14. The device of claim 13, wherein the plurality of first opening columns is staggered axially from the plurality of second opening columns.

15. The device of claim 1, further comprising a drain hole defined in a bottom of the hollow body.

16. A hose attachment device, comprising:
a hollow body having an interior bore configured to be placed into liquid communication with a garden hose such that water flows from the garden hose into the interior bore; and
a plurality of openings defined within the hollow body and configured to enable the flow of water out of the interior bore,
wherein the hollow body substantially maintains its position within a container as the container is filling with water flowing from the garden hose and out of the plurality of openings, substantially regardless of water pressure, without the hose attachment device being attached to the container or another stationary object and without the hose attachment device being held by a person during filling.

17. A method of filling a container with water from a garden hose using a hose attachment device having a hollow body with an interior bore and a plurality of openings configured to enable a flow of water out of the interior bore, the method comprising:
placing the hose attachment device into liquid communication with a garden hose such that water flows from the garden hose into the interior bore;
placing the hose attachment device into a container to be filled with water from the garden hose;
flowing water from the garden hose through the interior bore and out of the plurality of openings defined within the hollow body; and
substantially maintaining a position of the hose attachment device within the container as the container is filling with water flowing from the garden hose and out of the plurality of openings, substantially regardless of water pressure, without the hose attachment device being attached to the container or another stationary object and without the hose attachment device being held by a person during filling.

18. The method of claim 17, further comprising threadably securing the hose attachment device onto a threaded end of the garden hose.

19. The method of claim 17, further comprising substantially distributing the flow of water out of the plurality of openings in a substantially 360-degree flow pattern.
